(19) United States
(12) Patent Application Publication
(10) Pub. No.: US 2026/0039443 A1
(43) Pub. Date: Feb. 5, 2026

(54) METHODS AND APPARATUSES FOR OPERATIONS USING A DEDICATED CHANNEL IN A WLAN

(71) Applicant: INTERDIGITAL PATENT HOLDINGS, INC., Wilmington, DE (US)

(72) Inventors: Hanqing LOU, Syosset, NY (US); Rui YANG, Greenlawn, NY (US); Ying WANG, Easton, PA (US); Mahmoud SAAD, Montreal (CA)

(21) Appl. No.: 18/791,521

(22) Filed: Aug. 1, 2024

(51) Int. Cl. H04L 5/00; H04W 52/02

(52) U.S. Cl. CPC H04L 5/0092; H04W 52/0235

(57) ABSTRACT

Methods and apparatuses are disclosed for stations (STAs) in a Wireless Local Area Network (WLAN) to use a dedicated channel for various operations, including operations related to, for example, low latency traffic, wakeup radio (WUR), channel switching, power mode, and coexistence interference. The STA uses the dedicated channel in accordance with a configuration of the dedicated channel determined, for example, by receiving configuration information in a beacon frame from an access point (AP). The dedicated channel may include one or more resource units (RUs) and be included in physical protocol data units (PPDUs) received and/or transmitted by the STA. An STA may include an AP. Multiple embodiments of methods and apparatuses are disclosed.

### BACKGROUND

A wireless local area network (WLAN) in Infrastructure Basic Service Set (BSS) mode has an Access Point (AP) for the BSS and one or more stations (STAs) associated with the AP. The AP typically has access or interfaces to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA. During the conveyance of certain kinds of traffic, referred to herein as “low latency traffic,” such as traffic for which it may be necessary or desirable to meet, for example, certain maximum delay and/or jitter requirements, it may occur that the wireless medium becomes unavailable for other traffic, including control and/or management signaling. It may be desirable, therefore, to implement arrangements for improving the availability of the wireless medium.

### SUMMARY

One or more of the foregoing issues or needs may be addressed by aspects of the embodiments disclosed herein.

In certain aspects, embodiments of a station (STA) are disclosed comprising a transceiver and a processor, the transceiver and processor configured to: determine a configuration of a dedicated channel; and receive or transmit a physical protocol data unit (PPDU) including the dedicated channel, the dedicated channel carrying information indicating an operation type from a plurality of operation types, wherein the information indicating the operation type is carried over the dedicated channel in accordance with the configuration of the dedicated channel.

In certain aspects, embodiments of a method are disclosed for a station (STA), the method comprising: determining a configuration of a dedicated channel; and receiving or transmitting a physical protocol data unit (PPDU) including the dedicated channel, the dedicated channel carrying information indicating an operation type from a plurality of operation types, wherein the information indicating the operation type is carried over the dedicated channel in accordance with the configuration of the dedicated channel.

In further aspects, the plurality of operation types may include one or more of an indication that the dedicated channel is unused, a low latency traffic indication, a wakeup radio (WUR) indication, a channel switching indication, an end of channel switching indication, a power saving indication, an end of power saving indication, a beginning of coexistence interference indication, and an end of coexistence interference indication.

In further aspects, the STA may include an access point (AP).

Additional aspects are also disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a system diagram of an example wireless local area network (WLAN) in which one or more disclosed embodiments may be implemented;

FIG. 2B shows an exemplary format of a physical protocol data unit (PPDU) with a dedicated channel;

FIG. 3 shows an exemplary PPDU illustrating a representative operation with a sequence-based low latency traffic indication using a dedicated channel;

FIG. 4 shows an exemplary PPDU illustrating a further representative operation with a sequence-based low latency traffic indication using a dedicated channel;

FIG. 5 shows an exemplary PPDU illustrating a representative operation with a field-based low latency traffic indication using a dedicated channel;

FIG. 6 shows an exemplary PPDU illustrating a further representative operation with a field-based low latency traffic indication using a dedicated channel;

FIG. 7 shows a representative operation with a coexistence interference event using a dedicated channel; and

FIG. 8 shows a further representative operation with a coexistence interference event using a dedicated channel.

### DETAILED DESCRIPTION

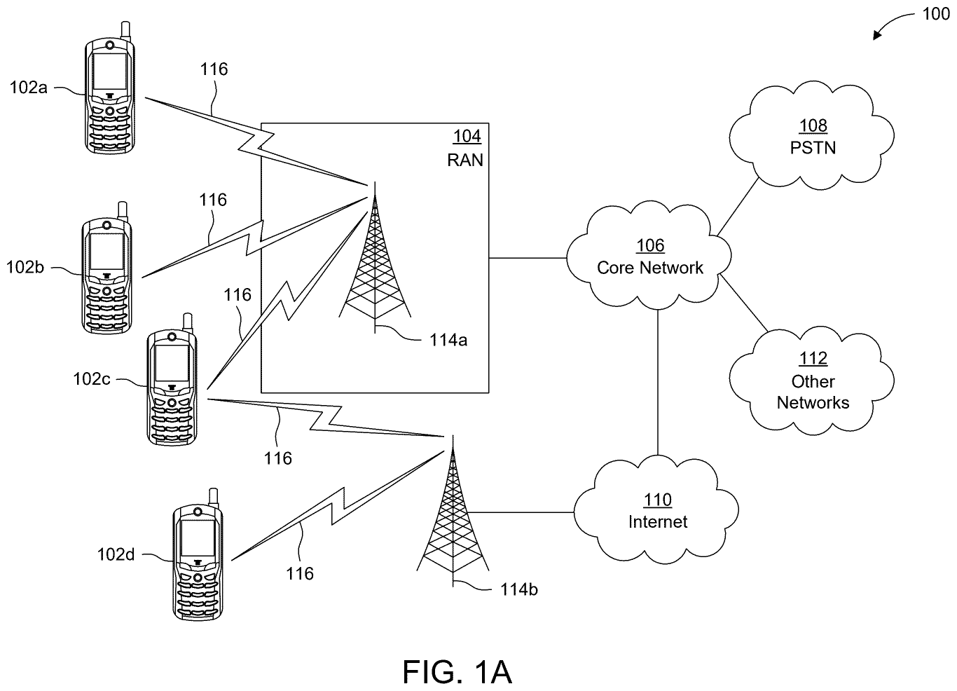

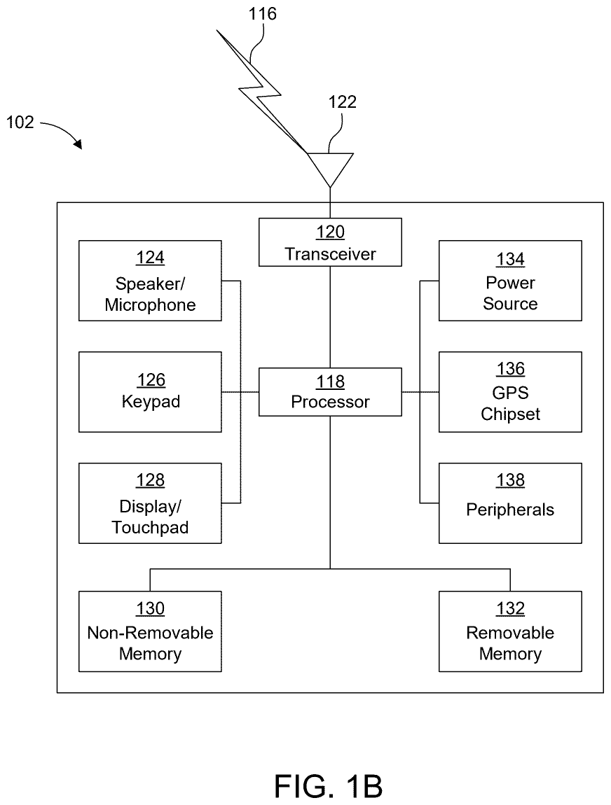

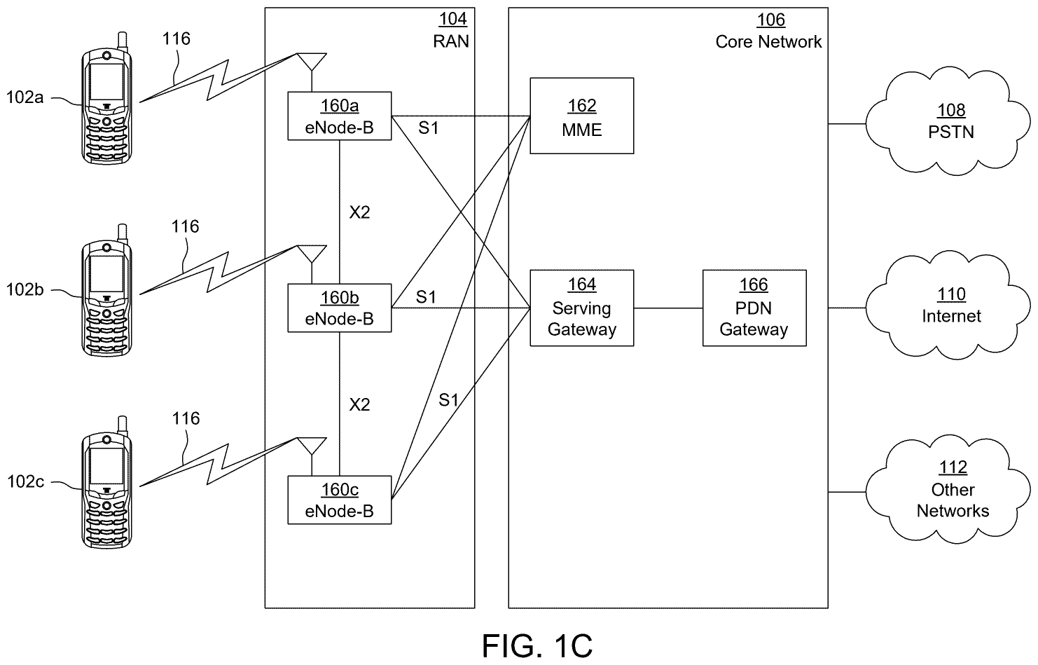

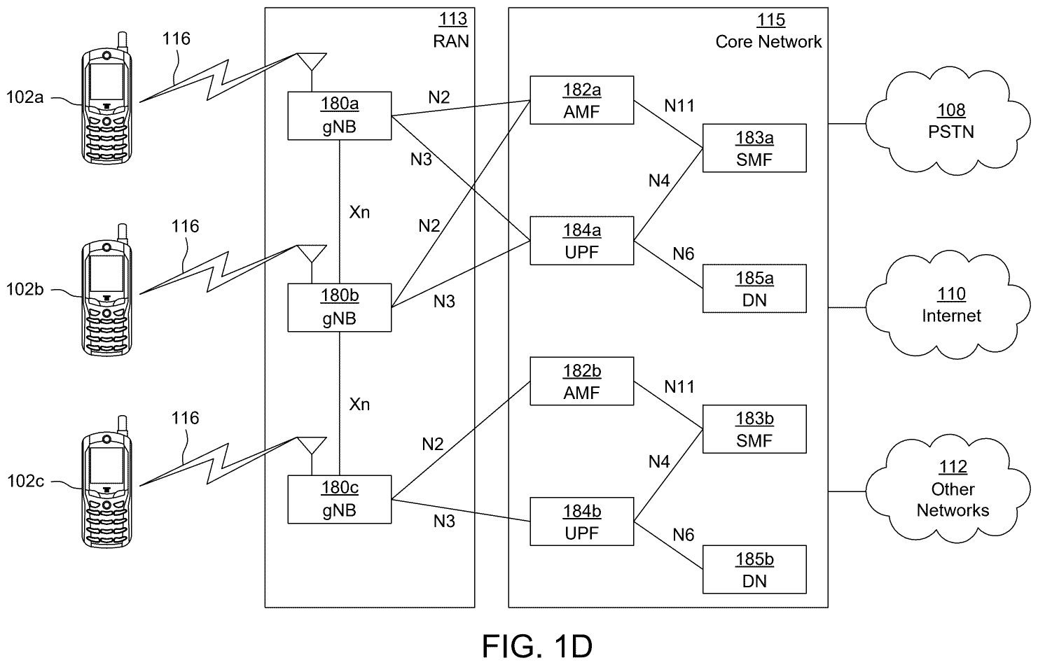

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHZ, 80 MHZ, and/or 160 MHz wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHZ channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

### Dedicated Channel Overview

### A Problem: Long PPDUs

When a STA successfully acquires the wireless medium, it may try to transmit its buffered data for as long as possible. This may result in a long PPDU, which usually is efficient since more data payload may be transmitted with limited overhead (e.g., preamble, contention time etc.) The transmission of a long PPDU, however, may block the use of the wireless medium by other users, including users with low latency traffic, or for urgent control or management signaling, which may have to wait until the end of the long PPDU to start contending for the wireless medium.

### A Solution: Dedicated Channel

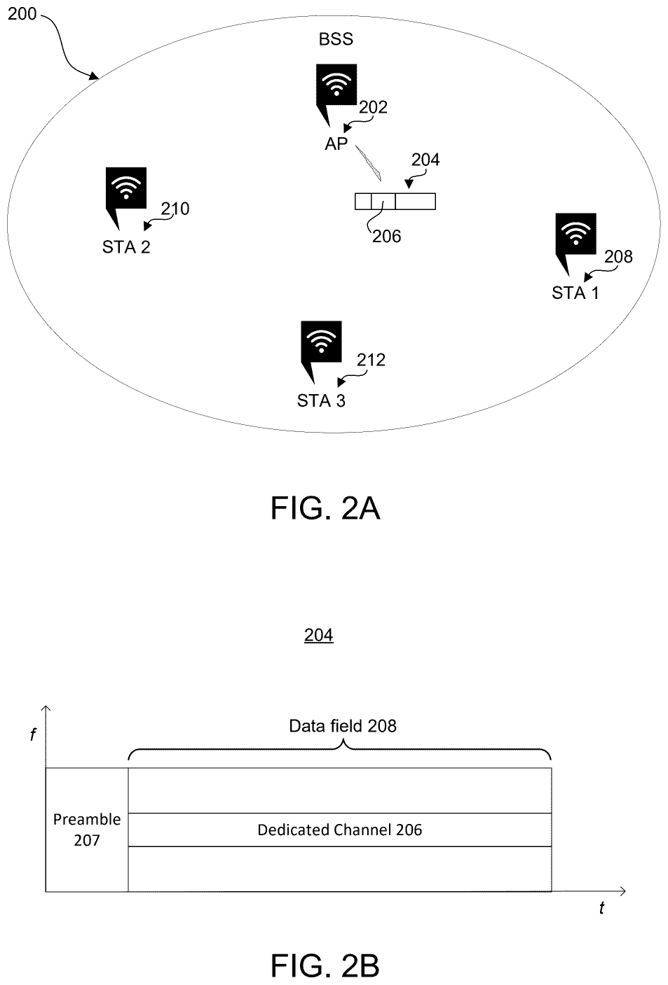

FIG. 2A shows an example WLAN 200 including an AP 202, a STA 208, a STA 210, and a STA 212. The WLAN 200 is in Infrastructure Basic Service Set (BSS) mode, with the STAs 208, 210, and 212 and the AP 202 considered to constitute a BSS. As depicted in FIG. 2A, AP 202 may transmit an Ultra High Reliability (UHR) and/or later generation (UHR+) physical protocol data unit (PPDU) 204 that includes information corresponding to a dedicated channel 206, comprising, for example, one or more predefined allocated resource units (RUs).

FIG. 2B shows an example of a PPDU 204 with a dedicated channel 206. At the beginning of PPDU 204 there is a preamble/PLCP header 207, which may be transmitted over the entire bandwidth. Some part of preamble 207 may be carried on a 20 Mhz subchannel and repeated on each 20 MHz subchannel if the operation channel width is greater than 20 MHz. A Data field 208 may follow the preamble. Dedicated channel 206 is present in Data field 208 of PPDU 204. Dedicated channel 206 may comprise one or more resource units (RUs), subchannels, or channels. For example, without limitation: the three RUs in the middle of the primary channel may be used for the dedicated channel; the dedicated channel may be a 20 MHz subchannel or multiple 20 MHz subchannels; or the dedicated channel may be an entire PPDU.

As described in greater detail below, dedicated channel 206 can be used to carry data corresponding to one or more operation type usages, such as one or more of the following:
Wake-up radio (WUR) signal transmissions.
Dynamic channel switching.
Power mode changes.
Coexistence interference indication.
Low latency traffic transmissions.
UHR/UHR+ broadcast/unicast signal transmissions.
UHR/UHR+ DL/UL control/management signal transmissions.
Any combination of the above.

### BSS Level Mechanisms

UHR/UHR+ STAs that can support the transmission and reception of PPDUs with a dedicated channel as disclosed herein may indicate their capability in a UHR Capabilities element or other element.

In exemplary embodiments, the configuration of the dedicated channel may be determined by the AP and indicated in one or more of a Beacon frame, Probe Response frame, (Re) Association Response frame, etc. For example, a Dedicated Channel element may be used to carry information regarding the configuration of the dedicated channel, such as, for example, the location and size of the dedicated channel. The Dedicated Channel element may also be carried by another element, such as a Multi-Link element, Reduced Neighbor Report element, Neighbor Report element, etc. In this way, the configuration of the dedicated channel may be changed from time to time. Moreover, with multi-link operation, the dedicated channel on a first link operated by an AP affiliated with an AP MLD may be announced by another AP affiliated with the same AP MLD on a second, different link. And thus, the STAs associated with the second AP on the second link may be informed of the configuration of the dedicated channel of the first AP affiliated with the same AP MLD.

In exemplary embodiments, the dedicated channel may be present in every UHR/UHR+ PPDU. For example, the AP may indicate in a Beacon frame the presence of the dedicated channel in every UHR/UHR+ PPDU in the beacon interval associated with the Beacon frame. A Dedicated Channel Present subfield may be defined and included in an element (e.g., Dedicated Channel Element) or field and carried in the Beacon frame. In exemplary embodiments, the presence of the dedicated channel in a UHR/UHR+ PPDU may be optional and signaled in the PLCP header of the PPDU, e.g., U-SIG field, UHR/UHR+ SIG field, etc. The AP may indicate in a Beacon frame the potential presence of the dedicated channel for the beacon interval. A Dedicated Channel subfield may be included in the U-SIG field (or other SIG field) to indicate whether a dedicated channel is present in the PPDU. In exemplary embodiments, the RU Allocation subfield in UHR/UHR+ SIG field (or other SIG field) may indicate that an RU is used as a dedicated RU to be used for the dedicated channel, or as a dedicated broadcast RU to be used for broadcast signaling. For example, one value of the RU Allocation subfield may indicate a 242-tone RU may be used for a dedicated channel. In exemplary embodiments, the User Specific field may carry a special association ID (AID) to indicate the RU corresponding to the AID is used as a dedicated channel. With trigger-based transmission, an AP may indicate the dedicated channel for the upcoming trigger-based PPDU (TB-PPDU) in the Trigger frame. For example, one AID 12 field in the User Info field in the Trigger frame may be set to a specific value to indicate that the corresponding RU defined in the User Info field is used for the dedicated channel. For example, a dedicated channel in the uplink may be reserved for low latency traffic delivery. Uplink OFDMA random access (UORA), for example, may be used for this dedicated channel.

When the dedicated channel is present, UHR/UHR+ STAs or UHR/UHR+ STAs capable of transmitting and/or receiving on the dedicated channel may need to decode the SIG field and/or data field(s) transmitted on the dedicated channel since they may be used to carry broadcast information for other UHR/UHR+ STAs.

### Usage Procedures

In exemplary embodiments, referred to herein as sequence-based, predefined/preconfigured sequences may be transmitted on the dedicated channel. Each such sequence may be a sequence of binary bits which may be mapped to a sequence of constellation symbols using a Gray or other suitable type of mapping with a specific modulation order (e.g., BSPK, QPSK, etc.) In one method, each sequence may be a sequence of binary symbols (e.g., constellation symbols on BSPK, QPSK, 16QAM, etc.) Each constellation symbol may be carried by a subcarrier in an OFDM symbol in the WiFi signal. The length of the sequence may depend on the size of the dedicated channel. A sequence may be modulated to one OFDM symbol or multiple OFDM symbols. For example, a sequence may have N constellation symbols and each dedicated channel may have M subcarriers, in which case the sequence may be modulated to ceiling (N/M) OFDM symbols.

Each sequence may have an associated meaning and used to indicate the corresponding signaling.
A predefined/preconfigured sequence, referred to as s0, may be transmitted on the dedicated channel to indicate that no information is carried in the dedicated channel. Sequence s0 may be considered a dummy sequence which indicates that the dedicated channel is not carrying information.
Any one of a set of predefined/preconfigured sequences s1, s2, . . . , s(N−1), may be transmitted on the dedicated channel to indicate different broadcast/unicast signaling for UHR/UHR+ STAs.
A predefined/preconfigured sequence sN may be transmitted on the dedicated channel to act as an ON symbol of a WUR signal.
The sequence used as the ON symbol for WUR, sequence sN, may be set to any predefined/predetermined/preconfigured sequence (for example, sequence s1, s2, . . . , s(N−1) used for UHR/UHR+ signaling) so that in the time domain the intended WUR receiver may detect enough energy for an ON symbol, while the intended UHR/UHR+ STAs may detect the sequence and thus understand the broadcast/unicast signaling. For example, sequence s2 may be used by the AP to request that one or more STAs switch to a secondary channel. Meanwhile the AP may use sequence s2 as a WUR ON signal to wake up a STA in WUR mode.

In exemplary embodiments, OFDMA modulated signals and normal MAC frames may be carried on the dedicated channel in an approach referred to herein as field-based. In such embodiments, the dedicated channel may be used to carry a MAC frame with type-dependent field(s), such as for example, a control frame, an Action frame, or a management frame with a Type field. Such a frame may be referred to as a Mode Change frame. A type may be defined for a corresponding specific usage of the dedicated channel. The Mode Change frame may have a Common Info field and a Type Dependent Info field. The Common Info field may carry information common to all types and the Type Dependent Info field may carry type-dependent information. A variable length padding field or padding bits may be added to the Mode Change frame so that it may be aligned with other transmissions. A special type of field composed of dummy symbols may be used to indicate that the dedicated channel contains no information. Whereas a Mode Change frame may be carried on the Dedicated channel, in general it may be carried by other resource units/subchannels/channels as well. Some procedures disclosed herein may be extended to cases in which Mode Change frames are carried in any resource unit in UHR/UHR+ PPDUs or even legacy PPDUs.

Exemplary usage cases for different sequences/type indices are shown in Table 1. The usage cases may include, for example, low latency traffic, dynamic channel switching, power save mode indication, coexistence interference, and/or WUR, among other possibilities.

In one method, UHR/UHR+ STAs that support dedicated channel transmission/reception may support some or all of the usage cases indicated in Table 1. A UHR/UHR+ STA may indicate its capabilities to support the usage cases of the dedicated channel in its UHR Capabilities element or a similar element and/or field. For example, a bitmap may be used to indicate the support for one or more usage cases.

TABLE 1
Usage of sequences/types in the dedicated channel

| Sequence/Type | |
|---|---|
| index | Meaning |
| 0 | Dummy |
| 1 | Low latency traffic indication |
| 2 | Dynamic channel switch indication |
| 3 | Power saving indication |
| 4 | Beginning of coexistence interference |
| 5 | End of coexistence interference |
| 6 | End of power saving indication |
| 7 | End of channel switch indication |
| 8 | WUR indication |

In one example, when sequence/type field 0 is used, the receiving UHR/UHR+ STAs may thus be informed that there is no information carried in the dedicated channel.

### Low Latency Traffic

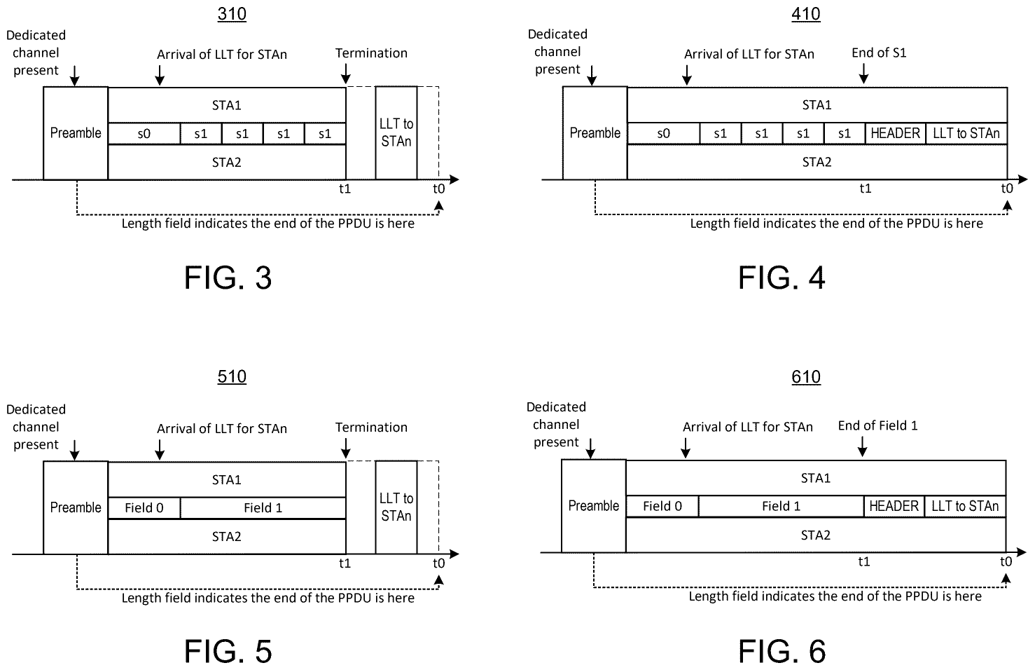

In this usage case, when sequence 1 or a Mode Change frame with Type field set to 1 is carried on the dedicated channel in a PPDU, receiving UHR/UHR+ STAs may thus be informed that a traffic flow with a low latency requirement has just arrived at the AP. It should be noted that the STA for which the low latency traffic (LLT) is intended may or may not be an intended recipient of the PPDU. For example, LLT for STA3 may arrive at the AP during the transmission from the AP of a PPDU intended for STA1 and STA2. The AP may use the dedicated channel to indicate the arrival of the low latency traffic. The transmitting STA (the AP in this example) may use one or more of the following procedures:
Method 1: Using sequence-based dedicated channel transmission, the transmitting STA may terminate the current PPDU transmission after N transmissions of the sequence 1 and transmit the low latency traffic after (e.g., as soon as practicable or later) or xIFS time after the termination of the PPDU. The value N may be predetermined or configured and signaled in a management/control frame by the AP. N may be selected based on considerations such as processing speed of the STAs, and/or channel conditions, for example, with N being greater for slower STAs and poorer channel conditions. Here xIFS refers to any defined inter-frame spacing. FIG. 3 illustrates such a procedure. Originally, a PPDU 310 is transmitted to STA1 and STA2 and sequence 0 is transmitted on the dedicated channel. The Length field in the Preamble of PPDU 310 indicates that the end of the PPDU is at t0. As depicted in FIG. 3, during transmission of PPDU 310, low latency traffic for STAn arrives. The transmitting STA, which as noted above is the AP in this example, may start transmitting sequence 1 on the dedicated channel. After N transmissions of sequence 1, with N=4 in this example, the transmitting STA terminates PPDU 310 at time t1, and xIFS time after t1 transmits the low latency traffic for STAn. STA1 and STA2 may monitor the transmission on the dedicated channel and may discard the received bits carried by the terminated PPDU 310.
Method 2: Using sequence-based dedicated channel transmission, the transmitting STA may transmit the low latency traffic after N transmissions of sequence 1 on the dedicated channel. A PHY layer signaling (e.g., one or more fields defined in U-SIG and/or UHR/UHR+ SIG may be included in the PHY layer signaling) may be carried after the N transmissions of the sequence and before the low latency traffic. The short header may indicate the STA ID of the STA intended to receive the low latency traffic. FIG. 4 illustrates such a procedure. Originally, a PPDU 410 is transmitted to STA1 and STA2 and sequence 0 is transmitted on the dedicated channel. The Length field in the Preamble of PPDU 410 indicates that the end of PPDU 410 is at t0. As depicted in FIG. 4, at some point during the transmission of PPDU 410, low latency traffic for STAn arrives at the transmitting STA, which in this example is the AP, as indicated above. The transmitting STA may start transmitting sequence 1 on the dedicated channel. After N transmissions of sequence 1 (here N=4) on the dedicated channel, the transmitting STA transmits the aforementioned short header identifying the intended recipient of the low latency traffic, STAn, followed by the low latency traffic for STAn.
Method 3: Using field-based dedicated channel transmission, the transmitting STA may terminate transmission of the current PPDU at the end of transmission on the dedicated channel of a Mode Change frame with Type field set to 1. It may transmit the low latency traffic after or xIFS time after the termination of the PPDU. FIG. 5 illustrates such a procedure. Originally, a PPDU 510 is transmitted to STA1 and STA2 and a Mode Change frame with Type field set to 0 is transmitted on the dedicated channel. The Length field in the Preamble of PPDU 510 indicates that the end of PPDU 510 is at t0. As depicted in FIG. 5, at some point during transmission of PPDU 510, low latency traffic for STAn arrives at the transmitting STA, which in this example is the AP, as indicated above. The transmitting STA may start transmitting on the dedicated channel a Mode Change frame with Type field set to 1. Upon the end of the transmission of the Mode Change frame at time t1, the transmitting STA terminates PPDU 510, and xIFS time after, the transmitting STA transmits the low latency traffic for STAn. STA1 and STA2 may monitor the transmission on the dedicated channel and discard the received bits carried by the terminated PPDU 510.
Method 4: Using field-based dedicated channel transmission, the transmitting STA may transmit the low latency traffic after the transmission of a Mode Change frame with type field set to 1 on the dedicated channel. A short header may be carried on the dedicated channel after the transmission of said Mode Change frame. The short header may indicate the STA ID of the STA intended to receive the low latency traffic. FIG. 6 illustrates such a procedure. Originally, a PPDU 610 is transmitted to STA1 and STA2 and a frame with field type 0 is transmitted on the dedicated channel. The Length field in the Preamble of PPDU 610 indicates that the end of PPDU 610 is at to. During the transmission of PPDU 610, low latency traffic for STAn arrives at the transmitting STA, which as indicated above is the AP in this example, after which the transmitting STA starts transmitting a Mode Change frame with type field set to 1 on the dedicated channel. After the transmission of the Mode Change frame has ended, the transmitting STA transmits on the dedicated channel a short header identifying STAn, the intended recipient of the low latency traffic, followed by the low latency traffic for STAn.

### Dynamic Channel Switch

In this usage case, when sequence 2 or a Mode Change frame with Type field set to 2 is carried on the dedicated channel in a PPDU, the receiving UHR/UHR+ STAs may thus be informed that a dynamic channel switch may happen. A dynamic channel switch is an operation which may entail a change in the center frequency and/or width of the channel that one or more STAs, whether or not an AP, are to monitor. In exemplary embodiments, a dynamic channel switch requiring the AP and its associated STAs to switch to another channel/subchannel may be carried out after the end of the PPDU in which the aforementioned sequence/field is sent on the dedicated channel. In one method, a subset of the STAs associated with the AP may be signaled to switch to another channel/subchannel. The configuration of a dynamic channel switch may be signaled before the PPDU in which the dynamic channel switch is signaled. For example, in a Beacon frame or a management frame, the AP may indicate the channel/subchannel (e.g., a secondary primary channel) that the AP and/or a subset or all of the STAs in the BSS may switch to when the dynamic channel switch is carried out.

An exemplary dynamic channel switch procedure using a dedicated channel may be implemented as follows.
An AP may include a dynamic channel switch element/field in a management frame (e.g., a Beacon frame), an action frame, or a control/data frame. The dynamic channel switch element/field may indicate one or more of the following:
   Channel/Subchannel Information: this field may indicate the channel the AP or UHR/UHR+ STAs in the BSS or a set of STAs in the BSS may switch to when dynamic channel switch operation is triggered. In one example, the channel center frequency and bandwidth/channel width of the new channel/subchannel may be carried in the field. The channel/subchannel indicated by the field may be referred to as the secondary primary channel.
   STA Group: this field may indicate a set of STAs which may switch to the channel indicated in the Channel/Subchannel Information field when the dynamic channel switch operation is triggered. In one method, the set of STAs may be signaled using their association IDs (AIDs). For example, a range of AIDs may be signaled to indicate STAs whose AID values are within the range. For example, an AID bitmap or partial AID bitmap may be used to indicate a group of STAs. In one method, the AP may negotiate with an associated STA in a unicast way as to whether the STA may be included in a group of STAs which are to switch to a secondary channel under certain conditions. The AP may give each group of STAs an index if more than one group is formed. The STA Group field may carry the group index.
   Return Criteria: this field may indicate the criteria used for returning to the primary channel. For example, the field may be set to a value of 1 to indicate returning to the primary channel after the transmit opportunity (TXOP) during which the AP and the non-AP STAs operate on the secondary channel. The field may be set to a value of 2 to indicate returning to the primary channel after the beacon interval.
   Operation Parameters: this subfield may contain multiple operation parameters for the secondary channel, such as, for example: the Maximum number of spatial streams to be transmitted/received on the secondary channel; the Maximum MCS to be transmitted/received on the secondary channel; the punctured subchannels on the secondary channel; the QoS stream (e.g., TIDs, ACs) to be transmitted/received on the secondary channel; etc.
A STA (whether or not an AP) may acquire the wireless medium and transmit a PPDU which carries sequence 2 or a Mode Change frame with Type field set to 2 on the dedicated channel to indicate the dynamic channel switch.
   If the STA is a non-AP STA, the STA may switch to the secondary primary channel after the end of the PPDU. The STA may stay on the secondary channel until the return criteria have been met. The AP may need to communicate with the STA on the secondary channel after the end of the PPDU.
   If the STA is an AP, the AP and its associated UHR/UHR+ STAs may switch to the secondary primary channel after the end of the PPDU. Or a group of STAs (e.g., the STAs indicated in the STA Group field in the dynamic channel switch element) may switch to the secondary primary channel after the end of the PPDU. The STAs may stay on the secondary channel until the return criteria have been met. The non-AP STAs may use the rest of the transmission time of the current PPDU to switch from the primary channel to the secondary channel.
   If the field-based approach is used, the Mode Change frame may carry information such as:
      Mode Change Duration: this subfield may indicate the time duration the STA may stay on the secondary channel.
      Operation Parameters: this subfield may contain multiple operation parameters for the secondary channel. For example, the Maximum number of spatial streams to be transmitted/received on the secondary channel; the Maximum MCS to be transmitted/received on the secondary channel; the punctured subchannels on the secondary channel; the QoS stream (e.g., TIDs, ACs) to be transmitted/received on the secondary channel, etc.

In one method, an STA (whether or not an AP) may use the dedicated channel to indicate that it may switch back from the secondary primary channel to the primary channel by including a sequence 7 or a frame with Type field indicating 7.

### Power Saving

In this usage case, when sequence 3 or a Mode Change frame with Type field set to 3 is transmitted by a STA on the dedicated channel in a PPDU, the receiving UHR/UHR+ STAs may thus be informed that the transmitting STA may switch to a power saving mode. In one method, the transmitting STA may enter the power saving mode after the end of the PPDU. The power saving mode may refer to an operation mode with a set of predefined/preconfigured operation parameters. For example, an STA in a power saving mode may transmit/receive using a lower order modulation and coding scheme (MCS), a smaller number of spatial streams, monitor a narrowband channel, etc.

When sequence 6 or a Mode Change frame with Type field set to 6 is carried on the dedicated channel in a PPDU, receiving UHR/UHR+ STAs may thus be informed that the transmitting STA may switch to a normal operation mode. In one method, the transmitting STA may enter the normal operation mode after the end of said PPDU. The normal operation mode may refer to an operation mode with a set of predefined/preconfigured operation parameters. For example, an STA in normal operation mode may transmit/receive using high MCS, a greater number of spatial streams, monitor a wideband channel, etc.

In one method, a STA originally in the power saving mode may switch to the normal operation mode during a TXOP and return to the power saving mode after the TXOP. In one method, a STA originally in the normal operation mode may switch to the power saving mode during a TXOP and return to the normal operation mode after the TXOP.

The detailed power saving and normal operating parameters of an AP may be broadcast by the AP in a management frame (e.g., a Beacon frame) or an action frame, a control frame, etc. A non-AP STA may exchange its power saving operating parameters with its associated AP in a unicast way by sending a control, action, management, or data frame. A Power Saving element/field may include one or more of the following:
Operation Parameters in normal operation mode: this subfield may contain multiple operation parameters for the normal operation mode, such as for example: the Maximum number of spatial streams to be transmitted/received; the Maximum MCS to be transmitted/received; the punctured subchannels; the QoS stream (e.g., TIDs, ACs) to be transmitted/received; the maximum channel width to be operate; etc.
Operation Parameters in power saving mode: this subfield may contain multiple operation parameters for the power saving mode, such as for example: the Maximum number of spatial streams to be transmitted/received; the Maximum MCS to be transmitted/received; the punctured subchannels; the QoS stream (e.g., TIDs, ACs) to be transmitted/received; the maximum channel width to be operate; etc.
Return Criteria: this field may indicate the criteria used for returning to the original mode. For example, this field may set to a value of 1 to indicate returning to the original mode after the TXOP, or to a value of 2 to indicate returning to the original mode after the beacon interval.

An exemplary power saving procedure using a dedicated channel is as follows.
An AP may include a power saving element/field in a management frame (e.g., a Beacon frame), an action frame, or a control/data frame. The power saving element/field may indicate the maximum MCS, maximum number of spatial streams, and/or maximum operation channel width when the AP is in power saving mode and/or normal operation mode.
A non-AP STA may include a power saving element/field in a management frame, an action frame, a control frame, or a MAC header of a management/data/control frame. The power saving element/field may indicate the maximum MCS, maximum number of spatial streams, and/or maximum operation channel width when the STA is in power saving mode and/or normal operation mode.
A STA (whether or not an AP) may acquire the wireless medium and transmit a PPDU which carries sequence 6 or a Mode Change frame with Type field set to 6 on the dedicated channel to indicate the switch from the power saving mode to the normal operation mode. After the transmission of the PPDU, the STA may go to normal operation mode using the parameters indicated in the power saving element/field.
   If the field-based method is used, the Mode Change frame may carry information such as:
      Mode Change Duration: this subfield may indicate the time duration the STA may stay in the normal operation mode.
      Operation Parameters: this subfield may contain multiple operation parameters for the normal operation mode. For example, the Maximum number of spatial streams to be transmitted/received in the normal operation mode; the Maximum MCS to be transmitted/received in the normal operation mode; the punctured subchannels in the normal operation mode; the QoS stream (e.g., TIDs, ACs) to be transmitted/received in the normal operation mode, etc.
The STA (whether or not an AP) may transmit a PPDU carrying sequence 3 or a Mode Change frame with Type field set to 3 on the dedicated channel to indicate the switch from normal operation mode to power saving mode. After the transmission of the PPDU, the STA may go to normal operation mode using the parameters indicated in the power saving element/field.
   If the field-based method is used, the Mode Change frame may carry information such as:
      Mode Change Duration: this subfield may indicate the time duration the STA may stay in the power saving mode.
      Operation Parameters: this subfield may contain multiple operation parameters for the power saving mode. For example, the Maximum number of spatial streams to be transmitted/received in the power saving mode; the Maximum MCS to be transmitted/received in the power saving mode; the punctured subchannels in the power saving mode; the QoS stream (e.g., TIDs, ACs) to be transmitted/received in the power saving mode, etc.

### Coexistence Interference

In this usage case, when sequence 4 or a Mode Change frame with Type field set to 4 is transmitted by a STA on the dedicated channel in a PPDU, the receiving UHR/UHR+ STAs may thus be informed that the transmitting STA may predict that it will experience in-device or general coexistence interference. The STA may acquire this information from higher layer signaling since the coexistence interference may be from another radio of the same device. In one method, the transmitting STA may include more detailed information about the coexistence interference in a separate transmission after the PPDU. In one method, the transmitting STA may predict a series of coexistence interference events to happen periodically or aperiodically and may set operation parameters to be used when the interference occurs. For example, a Coexistence Interference element/field may be used to carry information such as Maximum Transmit/Receive MCS, Maximum Number of Spatial Streams, Maximum Channel Width, Dynamic Preamble Puncturing Info, Maximum Transmit Power, Maximum and Minimum Expected Receive Power, etc. The parameters carried in the Coexistence Interference element/field are used when the interference occurs, and may include:
Maximum Transmit/Receive MCS: This field may indicate the maximum transmit and/or receive modulation and coding scheme (MCS) used by the transmitting STA during an interference event.
Maximum Number of Spatial Streams: This field may indicate the maximum number of spatial streams the transmitting STA may transmit and/or receive during an interference event.
Maximum Channel Width: This field may indicate the maximum transmit and/or receive channel width used by the transmitting STA during an interference event.
Dynamic Preamble Puncturing Info: This field may indicate the punctured channels/subchannels of the transmitting STA during an interference event.
Maximum Transmit Power: This field may indicate the maximum transmit power used by the transmitting STA during an interference event.
Maximum and Minimum Expected Receive Power: This field may indicate the maximum and/or minimum expected receive power or RSSI of the transmitting STA during an interference event.
Unavailable: this field may indicate the STA is not able to communicate with other STAs during an interference event. If this field is set, the rest of the fields may be reserved.
Interference Type: this field may indicate the interference type. For example, it may be a Bluetooth signal, an ultra-wideband (UWB) signal, a Zigbee signal, a WiFi signal on an adjacent channel, etc. In another example, it may indicate the interference signal is a standalone signal, a recurring signal, a periodic signal, a frequency static signal, a frequency hopping signal, etc.
Impact Factor: this field may indicate if the interference signal is always present. For example, Impact Factor set to 0 may indicate that the predicted interference signal is always present or the other STAs in the BSS need to stop communicating with the affected STA during the interference event. Impact Factor set to 1 may indicate that the expected interference signal may be present if it wins contention for the wireless medium. In this case, the other STAs in the BSS may try to communicate with the affected STA during the interference event.

An AP may transmit the Coexistence Interference element/field in a management frame (e.g., a Beacon frame) or an action frame, a control frame, etc. A non-AP STA may exchange its Coexistence Interference element with its associated AP in a unicast way by sending a control, action, management, or data frame. Before each interference event, the STA/AP may transmit a PPDU with the dedicated channel indicating the presence of the interference. After each interference event, the STA/AP may transmit a PPDU with sequence 5 or a Mode Change frame with Type field set to 5 in the dedicated channel to indicate the end of the interference.

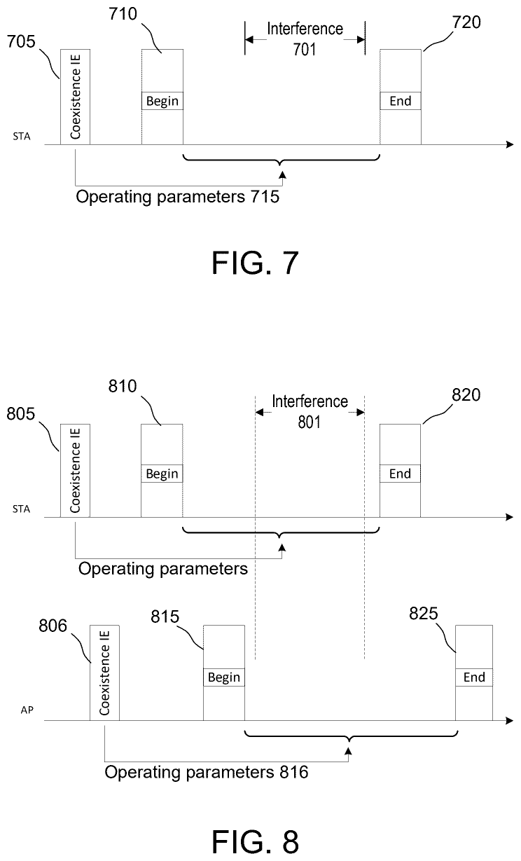

An exemplary coexistence interference procedure using a dedicated channel will now be described with reference to FIG. 7.
A STA (whether or not an AP) may transmit its Coexistence Interference element/field if it predicts a coexistence interference event 701.
   If the STA is an AP, it may include a Coexistence Interference element/field in a frame 705, which may be a management frame (e.g., a Beacon frame), an action frame, a control frame, and/or a data frame.
   If the STA is a non-AP STA, it may include a Coexistence Interference element/field in frame 705, which may be a management frame, an action frame, a control frame, or a MAC header of a management/data/control frame.
The STA which transmitted the Coexistence Interference element/field, may predict that the interference event 701 may happen soon. For example, it may happen within a certain time. The STA may acquire the wireless medium and transmit a PPDU 710 which carries sequence 4 or a Mode Change frame with Type field set to 4 on the dedicated channel to indicate the beginning of the coexistence interference event 701. After the transmission of PPDU 710, the other STAs may use the parameters 715 indicated in the Coexistence Interference element/field to communicate with the STA. Note that it may be difficult for a STA to transmit a PPDU right before the interference event, and therefore the transmission of PPDU 710 may be carried out at a period before the predicted interference event 701, depending on implementation and network conditions.
   If the field-based method is used, the Mode Change frame may carry information such as:
      Mode Change Duration: this subfield may indicate the time duration the STA may stay under the impact of coexistence interference event.
      Operation Parameters: this subfield may contain multiple operation parameters 715 to be used for transmission and reception during the coexistence interference event 701. For example, the Maximum number of spatial streams to be transmitted/received; the Maximum MCS to be transmitted/received; the punctured subchannels; the QoS stream (e.g., TIDs, ACs) to be transmitted/received.
The STA may acquire the wireless medium after the end of the interference event 701. The STA may transmit a PPDU 720 which carries sequence 5 or a Mode Change frame with Type field set to 5 on the dedicated channel to indicate the end of the coexistence interference event 701. After the transmission of PPDU 720, the other STAs may communicate with the STA using normal operation parameters. Note that it may be difficult for a STA to transmit a PPDU after the end of the interference event, and therefore the transmission of the PPDU may be at a period after the end of the interference event 701 depending on implementation and network conditions.

An AP may relay to all STAs in the BSS an indication from one STA of coexistence interference so that they may be informed of the interference. An exemplary such procedure will now be described with reference to FIG. 8.
A non-AP STA may predict a coexistence interference event 801 and indicate the predicted coexistence interference event by including a Coexistence Interference element/field in a frame 805, which may be a management frame, an action frame, a control frame, or a MAC header of a management/data/control frame.
On reception of the Coexistence Interference element/field from the non-AP STA, the AP may determine to update its operation parameters used during the Coexistence event by including a Coexistence Interference element/field in a frame 806, which may be a management frame (e.g., a Beacon frame), an action frame, or a control/data frame based on the content of the Coexistence Interference element/field received. For example, if the coexistence interference to the non-AP STA may impact the AP and its surrounding STAs, then the AP may update its operation parameters 816.
The non-AP STA may predict the interference event 801 may happen soon. For example, it may happen within a certain time. It may acquire the wireless medium and transmit a PPDU 810 which carries sequence 4 or a Mode Change frame with Type field set to 4 on the dedicated channel to indicate the beginning of the coexistence interference event 801. After the transmission of PPDU 810, the other STAs may use the parameters indicated in the Coexistence Interference element/field in frame 805 to communicate with the STA.
On reception of the beginning of the coexistence interference indication from the non-AP STA, the AP may determine to relay the information to its associated STAs if the interference indicated by the non-AP STA is significant enough to impact the transmission and/or reception of the AP. For example, if the RSSI measured by the AP based on a PPDU transmitted by the STA is greater than a predefined/preconfigured threshold, then the AP may determine that the STA is close to the AP, in which case interference event 801 of the STA may have a significant impact to the AP. The AP may acquire the wireless medium and transmit a PPDU 815 which carries sequence 4 or a Mode Change frame with Type field set to 4 on the dedicated channel to indicate the beginning of the coexistence interference. After the transmission of PPDU 815, the other STAs may use the parameters 816 indicated in the Coexistence Interference element/field to communicate with the AP.
The non-AP STA may acquire the wireless medium after the end of interference event 801. It may transmit a PPDU 820 which carries sequence 5 or a Mode Change frame with Type field set to 5 on the dedicated channel to indicate the end of the coexistence interference. After the transmission of PPDU 820, the other STAs may communicate with the STA using normal operation parameters. Note it may be difficult for a STA to transmit a PPDU after the end of interference event, and therefore the transmission of PPDU 820 may be at a period after the end of the interference event depending on implementation and network conditions.
On reception of the end of the inference indication in PPDU 820 from the non-AP STA, if the AP had sent PPDU 815 indicating the beginning of interference event 801, the AP may acquire the wireless medium and transmit a PPDU 825 carrying sequence 5 or a Mode Change frame with Type field set to 5 on the dedicated channel to indicate the end of the coexistence interference event 801. After the transmission of PPDU 825, the other STAs may use normal operation parameters to communicate with the AP.

The above-described mechanisms may be generalized for usage cases other than Coexistence Interference. For example, various usage cases (e.g., low latency traffic indication, dynamic channel switch, power saving, etc.) may entail a mode change, with a mode begin indication carried on the dedicated channel before the mode change and a mode end indication carried on the dedicated channel to indicate the period of the mode change, similar to the procedure shown in FIG. 7. The AP or other STAs may relay the mode change indications, similar to the procedure shown in FIG. 8.

### Wake Up Radio

In this usage case, when sequence 8 or a Mode Change frame with Type field set to 8 is carried on the dedicated channel in a PPDU, the receiving UHR/UHR+ STAs may thus be informed that a WUR signal may follow and be carried on the dedicated channel.

If sequence-based dedicated channel transmission is used, the transmitting STA may transmit the WUR signal after N transmissions of sequence 8 on the dedicated channel. The value N may be predetermined or configured and signaled in a management/control frame by the AP.

If field-based dedicated channel transmission is used, the transmitting STA may transmit the WUR signal after the transmission of a frame (e.g., a Mode Change frame with type field set to 8) on the dedicated channel.

Various numeric values are used in the present disclosure. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. So, in this example, a first operation need not be performed before a second operation, and may occur, for example, before, during, or in an overlapping time period with the second operation.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors may also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information may include one or more of, for example, estimating the information, calculating the information, predicting the information, or retrieving the information from memory.

Further, this disclosure may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter-frame spacing in the examples of the designs and procedures, all other inter-frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A station (STA) comprising:
a transceiver; and
a processor,
wherein the transceiver and processor are configured to:
determine a configuration of a dedicated channel; and
receive or transmit a physical protocol data unit (PPDU) including the dedicated channel, the dedicated channel carrying information indicating an operation type from a plurality of operation types,
wherein the information indicating the operation type is carried over the dedicated channel in accordance with the configuration of the dedicated channel.

2. The STA of claim 1, wherein determining the configuration of the dedicated channel includes receiving a frame having information indicating the configuration of the dedicated channel, the frame including a beacon frame from an access point (AP), the beacon frame including information indicating that the PPDU and other PPDUs within a beacon interval include the dedicated channel.

3. The STA of claim 1, wherein the plurality of operation types includes one or more of an indication that the dedicated channel is unused, a low latency traffic indication, a wakeup radio (WUR) indication, a channel switching indication, an end of channel switching indication, a power saving indication, an end of power saving indication, a beginning of coexistence interference indication, and an end of coexistence interference indication.

4. The STA of claim 1, wherein the information indicating the operation type is in one or more fields of the PPDU.

5. The STA of claim 1, wherein the information indicating the operation type includes a respective sequence of bits or symbols corresponding to a respective operation.

6. The STA of claim 5, wherein the PPDU is terminated following a transmission of the respective sequence a plurality of times.

7. The STA of claim 1, wherein the dedicated channel carries low latency traffic for at least one of the STA or another STA.

8. The STA of claim 1, wherein the transceiver and processor are configured to:
transmit or receive coexistence interference parameters in a frame, and
transmit or receive, over the dedicated channel, at least one of a beginning of coexistence interference indication or an end of coexistence interference indication.

9. The STA of claim 1, wherein the PPDU includes a preamble, the preamble including information indicating a presence of the dedicated channel in the PPDU.

10. The STA of claim 1, wherein the configuration of the dedicated channel includes a location and size of the dedicated channel.

11. The STA of claim 1, wherein the STA includes an access point (AP).

12. A method for a station (STA), the method comprising:
determining a configuration of a dedicated channel; and
receiving or transmitting a physical protocol data unit (PPDU) including the dedicated channel, the dedicated channel carrying information indicating an operation type from a plurality of operation types,
wherein the information indicating the operation type is carried over the dedicated channel in accordance with the configuration of the dedicated channel.

13. The method of claim 12, wherein determining the configuration of the dedicated channel includes receiving a frame having information indicating the configuration of the dedicated channel, the frame including a beacon frame from an access point (AP), the beacon frame including information indicating that the PPDU and other PPDUs within a beacon interval include the dedicated channel.

14. The method of claim 12, wherein the plurality of operation types includes one or more of an indication that the dedicated channel is unused, a low latency traffic indication, a wakeup radio (WUR) indication, a channel switching indication, an end of channel switching indication, a power saving indication, an end of power saving indication, a beginning of coexistence interference indication, and an end of coexistence interference indication.

15. The method of claim 12, wherein the information indicating the operation type is in one or more fields of the PPDU.

16. The method of claim 12, wherein the information indicating the operation type includes a respective sequence of bits or symbols corresponding to a respective operation.

17. The method of claim 12 comprising:
transmitting or receiving coexistence interference parameters in a frame, and
transmitting or receiving, over the dedicated channel, at least one of a beginning of coexistence interference indication or an end of coexistence interference indication.

18. The method of claim 12, wherein the configuration of the dedicated channel includes a location and size of the dedicated channel.

19. The method of claim 12, wherein the PPDU includes a preamble, the preamble including information indicating a presence of the dedicated channel in the PPDU.

20. The method of claim 12, wherein the STA includes an access point (AP).
